(19) United States
(12) Patent Application Publication
(10) Pub. No.: US 2008/0210853 A1
(43) Pub. Date: Sep. 4, 2008

(54) Medical apparatus and procedure for positioning a patient in an isocenter

(76) Inventors: Konstanze Gunzert-Marx, Erlangen (DE); Tim Use, Nurnberg (DE)

Correspondence Address: BRINKS HOFER GILSON & LIONE, P.O. BOX 10395, CHICAGO, IL, 60610, US

(21) Appl. No.: 11/800,340

(22) Filed: May 4, 2007

(30) Foreign Application Priority Data
May 9, 2006 (DE) DE 102006021632.6

(51) Int. Cl. G12B 13/00

(52) U.S. Cl. 250/252.1

(57) ABSTRACT

A medical device, in particular a radiation therapy device, includes both an examination table that can be positioned at an isocenter and an optical coordinate display system. The optical coordinate display system has at least one radiation source, in particular a laser emitter, that is intended for emitting a test beam. Simplified and more-objective checking of the positioning accuracy of the examination table is effected via a test body for beam detection. The test body includes at least one photoelectric line, constructed of a row of photoelectric cells, the position of the line being coordinated with that of the examination table.

The present patent document claims the benefit of the filing date of DE 10 2006 021 632.6, filed May 9, 2006, which is hereby incorporated by reference.

### BACKGROUND

The present embodiments relate to a device that checks the positioning accuracy of an examination table relative to an isocenter of a medical device. The present embodiments also relate to a test body and to a method for checking the positioning accuracy of an examination table relative to an isocenter of a medical device.

The correct positioning of the patient relative to a medical device is of major significance for the therapy of a patient. In particle therapy, the positioning accuracy of the particle beam is significantly better than in conventional photon irradiation or proton irradiation with scattering. The exact positioning of the tissue to be irradiated at the isocenter of the radiation therapy device is of fundamental importance. The positioning accuracy of the examination table and its replicability are subject to high (rigid) demands. The high demands keep any errors as slight as possible.

The correct positioning of the patient requires the exact determination of a three-dimensional coordinate system. Typically, a laser coordinate display system is calibrated with a theodolite upon installation and again once a year. The laser emitter coordinate display system generally includes at least three linear beam fans whose point of intersection indicates the location of the isocenter. The three linear beam fans are oriented orthogonally to one another. For checking the positioning accuracy, test bodies, for example, phantoms, with markings are mounted at fixed positions on the examination table.

The test bodies may be used to ascertain and correct inaccuracies in the position compared to the laser coordinate display system. Conventionally, the positioning of the test bodies relative to the laser coordinate display system is done visually by the assigned equipment operator.

### SUMMARY

The present embodiments may obviate one or more of the drawbacks or limitations inherent in the related art. For example, in one embodiment, a device is able to simplify checking the positioning accuracy of an examination table of a medical device in a laser coordinate display system.

In one embodiment, a medical device, for example, a radiation therapy device, includes an examination table that can be positioned at an isocenter and an optical coordinate display system that has at least one radiation source, for example, a laser emitter, intended to emit a test beam. A test body for radiation detection is used to check the positioning accuracy of the examination table. The test body includes at least one photoelectric line that includes a row of photoelectric cells. The position of the row of the photoelectric line correlates to that of the examination table.

The laser beam is aimed at the photoelectric line and triggered, and moved to form a beam fan. The beam fan of a laser line or test beam intersects the photoelectric line. The photoelectric cells that are illuminated by the test beam, furnish a signal to a control unit of the medical device. The signal is assessed by a computer, which obtains data about the accurate position coordinates, the orientation of the test body, or the combination thereof.

The beam, for example, a laser beam, emitted by the radiation source may be detected by a photoelectric line constructed of lined-up photoelectric cells. Direct visual monitoring by the operator of the medical device may be dispensed with because of the detection by a photoelectric line. Corresponding sources of error may be eliminated, and the accuracy of checking the coordinate system may be increased when suitably high-resolution photoelectric cells are used. The signals picked up by the photoelectric line may be automatically processed by the control unit that triggers the medical device. The accuracy may be improved and safety enhanced. The monitoring method may be automated and made more objective.

In one embodiment, the test body is a separate geometric object, which is positioned separately from the examination table at the isocenter via an adjusting device, for example, a robot arm, of the examination table. The correct coordinates of the test body relative to the isocenter are stored in memory, so that the examination table may be moved at any time later with the adjusting device into a defined position relative to the isocenter. In an alternative embodiment, the separate test body is mounted on the examination table. A direct correlation is set up between the separate test body coordinates and those of the examination table. In another embodiment, the test body is part of the examination table and includes a plurality of elements. The plurality of elements may be secured at different positions of the examination table or are integrated with the examination table.

The beam length of the test beam may be dimensioned relative to the photoelectric line such that the test beam strikes only a small number of the photoelectric cells of the photoelectric line. A signal, for example, a signal that exceeds an adjustable threshold, may be generated in only some of the photoelectric cells. A shift of the signal along the photoelectric cell may be detected. The photoelectric cell furnishes (provides) information about deviations in the position of the test body from the isocenter. Upon an initial calibration of the test body, the data about the location of the signal along each individual photoelectric line may be stored in memory as a neutral location. Upon checking the positioning accuracy of the test body the next time, the newly obtained data may be compared with the memorized neutral location of the signal in each photoelectric line.

In one embodiment, a plurality of photoelectric lines may form an angle, for example, a right angle, with one another. The position of the test body may be detected two- or three-dimensionally. The test body may be positioned in such a way that the positioning lines extend essentially along the axes of the coordinate display system. The exact position of the test body in the coordinate display system may be simply assessed.

In another embodiment, a plurality of photoelectric lines may be disposed parallel to one another and spaced apart from one another in the beam direction of the test beam. A displacement of the test body from the isocenter and also a rotation of the test body relative to the coordinate display system may be detected, for example, if two parallel, diametrically opposed photoelectric lines are illuminated with the test beam.

In one embodiment, a plurality of photoelectric lines may be arranged on an imaginary circle. A deviation of a large angular amount may be detected by a circular or arc-like arrangement of a plurality of photoelectric lines. Generally, the detection of a test body rotation by the parallel arrangement of photoelectric lines is limited by the size of the photoelectric lines, so that usually only deviations by only a few degrees are detectable. To check further angular positions that are an indication of a greater rotation relative to the axes of the coordinate display system, a plurality of photoelectric lines in one plane are required.

In one embodiment, the test body includes a connecting element for precise, replicable connection to the examination table. Because of the connection of the test body to the examination table, the position of the table in the coordinate display system may also defined.

The test body may be coupled at a coupling point to an adjusting device, for example, a robot arm, of the examination table. The test body may be coupled directly to the adjusting device via a tool-changing unit. After the positioning of the test body at the isocenter and the storage of the coordinates of the isocenter in memory, the test body may be exchanged for the examination table with the aid of the tool-changing unit, and the table may be moved into a defined position relative to the isocenter.

In one embodiment, a test body includes at least one photoelectric line constructed of a row of photoelectric cells. The test body is embodied as an upside-down table that includes a plate like base and at least one pillar disposed at a right angle to the base. At least two photoelectric lines may be disposed at an angle to one another and one further photoelectric line on the pillar may be provided on the base.

In one embodiment, a test body with a photoelectric line constructed of a row of photoelectric cells is put in a testing position. The photoelectric line may be irradiated with a test beam emitted by a radiation source of the coordinate display system. The position of the test body relative to the isocenter may be ascertained as a function of the signal picked up by the photoelectric line.

The embodiments discussed in terms of the medical device apply logically to a test body and a method as well.

In one embodiment, the location of the signal of the photoelectric line is compared with a neutral location. The neutral location may be defined upon a calibration of the test body in the coordinate display system. Displacements and possible rotations of the test body may be detected.

In one embodiment, to enable three-dimensional checking of the positioning accuracy of the test body and of the examination table, the test body is irradiated from a plurality of directions, for example, from three directions parallel to the axes of the coordinate display system.

In one embodiment, for ascertaining the position relative to the isocenter, the test body is moved, and the signal picked up by the photoelectric line. The deviations from the correct position are compensated for by the translational or rotary motions, until the neutral location of the signal on the photoelectric lines is reached.

The motions of the test body may serve to obtain information about the orientation of the test body. In one embodiment, only one photoelectric line per coordinate direction is provided. A deviation of the signal from the neutral location may indicate both a translational displacement and a rotation of the test body. In order to ascertain which of the two cases pertains, the test body is rotated in a plane about the assumed isocenter, for example, by 90°, and its position is checked again. If a shift in the signal of the individual photoelectric lines relative to its previous location is detected, then the pivot point of the test body in this plane does not match the isocenter.

### BRIEF DESCRIPTION OF THE DRAWINGS

FIG. 1 shows one embodiment of a medical device with an optical coordinate display system and a test body;

FIG. 2 shows one embodiment of a photoelectric line of the test body of FIG. 1;

FIG. 3 shows one embodiment of a first orientation of a plurality of photoelectric lines of the test body of FIG. 1 with respect to two test beams of the coordinate display system;

FIG. 4 shows one embodiment of a second orientation of a plurality of photoelectric lines of the test body of FIG. 1 with respect to two test beams of the coordinate display system;

FIG. 5 is a top view of a test body according to one embodiment, and

FIG. 6 is a perspective view of the test body of FIG. 5; and

FIGS. 7a-7c are top views of one embodiment of a test body in three different orientations relative to the coordinate display system.

### DETAILED DESCRIPTION

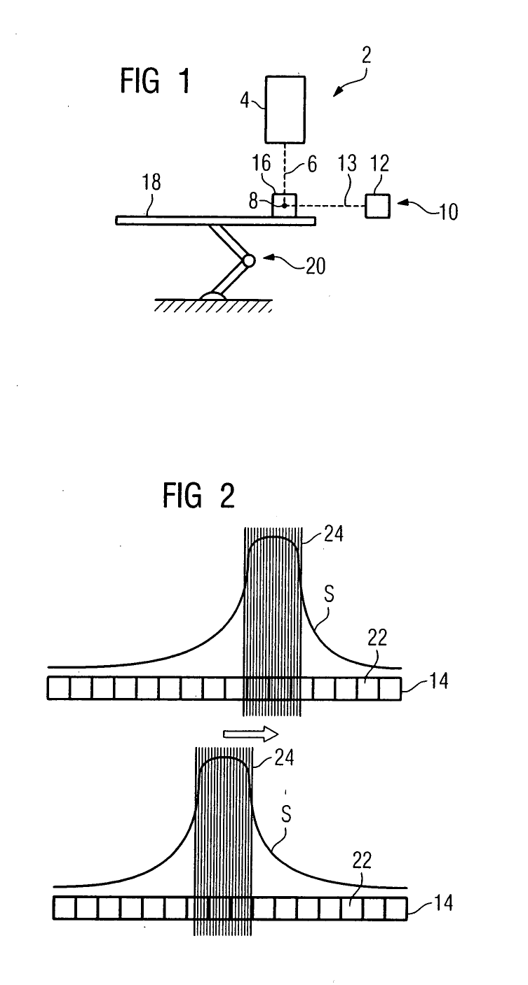

In one embodiment, as shown in FIG. 1, a medical device 2 includes a particle emitter 4, for example, a proton emitter or heavy-ion emitter, which during operation emits a particle beam 6. During radiation therapy, the particle beam 6 strikes tissue to be irradiated of a patient (not shown) at an isocenter 8.

The medical device 2 includes an optical coordinate display system 10, which includes a laser emitter as its radiation source 12. Photoelectric lines 14 (see FIGS. 2 through 6) are mounted on a test body 16. The photoelectric lines 14 may be used for detecting a laser beam 13 emitted by the laser emitter 12. In FIG. 1, only a single radiation source 12, which determines the position of the test body 16 in one direction of the coordinate display system 10, is shown schematically. However, there may be at least three laser emitters 12 that describe the axes of a coordinate system.

The test body 16 serves to check the positioning accuracy of an examination table 18 of the medical device 2 in the coordinate display system 10. In one exemplary embodiment, the test body 16 is a separate object. The test body 16 may be detachably connected to the examination table 18 and movable indirectly via an adjusting device 20 of the table 18. The positioning of the test body 16 on the examination table 18 is precise and replicable. An unambiguous correlation between the position of the test body 16 and that of the examination table 18 in the coordinate display system 10 may be assured.

In one embodiment, the laser emitters 12 and the test body 16 are connected in terms of data to a control unit of the medical device 2. The data obtained by the beam detection may be assessed in the control unit. The control unit may ascertain whether there are deviations in the position of the test body 16 relative to the isocenter 8. If deviations do exist, they may be corrected by the control unit, via the adjusting device 20, which varies the position of the table 18 and the test body 16 accordingly.

In one embodiment, the test body 16 also includes a plurality of elements. The plurality of elements may be mounted apart from one another on the examination table 18 or may be an integral component of the table 18. Alternatively, the test body 16 may be connected directly to the adjusting device 20 via a tool-changing unit or tool changer. After the positioning accuracy relative to the isocenter 8 has been checked, the test body 16 may be replaced by the table 18 using the tool changer. The table 18 may be repeatedly moved into defined desired positions relative to the isocenter 8.

In one embodiment, as shown in FIG. 2, the test body 16 may include a photoelectric line 14. The photoelectric line 14 may include a plurality of photoelectric cells 22 disposed geometrically in a row. CCD (charge coupled device) cells are, for example, used as the photoelectric cells 22. Any other photosensitive sensors may be equally well suited.

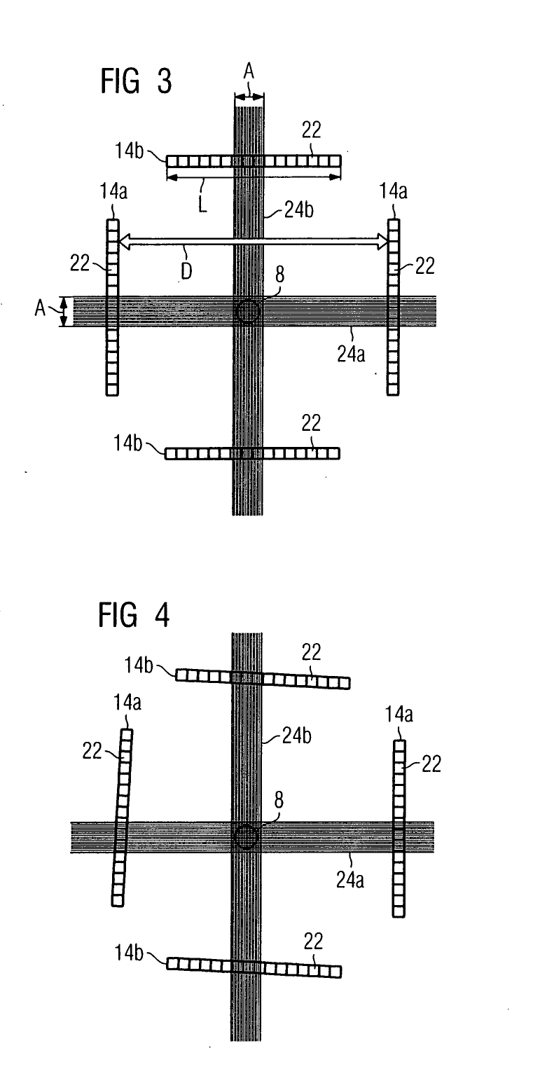

In FIG. 2, in addition to a photoelectric line 14, an electrical signal S furnished by it is shown for two different illuminations with a laser beam 13 of the radiation source 12. The laser beam 13 forms a beam fan, which in the manner of a laser line, as a test beam 24, intersects the photoelectric line 14. The beam length A (FIG. 3) may be dimensioned such that the test beam 24 strikes a small number of the photoelectric cells 22 of the photoelectric line 14.

The displacement of the test beam 24 from a first radiation position, for example, as shown at the bottom in FIG. 2, to a second radiation position is represented by an arrow. A high signal intensity is generated in those photoelectric cells 22 that are illuminated directly by the test beam 24. The signal S decreases with increasing distance from the center of the test beam 24. By assessing which of the photoelectric cells 22 are irradiated by the test beam 24, the position of the test beam 24 relative to the test body 16 may be ascertained. In one embodiment, only those photoelectric cells whose output signal value exceeds a threshold, for example, an adjustable threshold, are assessed as having been irradiated by the test beam 24.

In one embodiment, when a photoelectric cell 22, such as a light-sensitive photodiode, is illuminated, a charge occurs that is proportional to the intensity of the light striking it. In a first mode of signal processing, it is ascertained only whether the intensity of the light detected by the photoelectric cell 22 exceeds an adjustable threshold. The site of the radiation of the test beam 24 is defined by the coordinates of the photoelectric cell 22.—Alternatively, when there is a plurality of illuminated photoelectric cells 14, the site of the radiation of the test beam 24 is defined by the averaged coordinates of the affected photoelectric cells 14.

In an alternative method of signal processing, the exceeding of a threshold—and the intensity of the signal S at each illuminated photoelectric cell 22 is ascertained. Using the intensity of the signal S, for example, a higher resolution may be ascertained with a digital scale. The center of radiation of the test beam 24 may be determined with an accuracy that exceeds the local resolution of the individual photoelectric cells 22, or the dimensioning of the typically square photoelectric cells 22 in the direction in which the photoelectric line 14 extends.

How information about the position and orientation of the test body 16 in a two-dimensional plane is obtained is illustrated in FIG. 3 and FIG. 4. In FIG. 3, two photoelectric lines 14a are disposed parallel to one another. The spacing between the identical photoelectric lines 14a is indicated by D. Two further photoelectric lines 14b are disposed parallel to one another. Photoelectric lines 14b are disposed orthogonally to the photoelectric lines 14a. The total of four photoelectric lines 14a, 14b are disposed on the sides of an imaginary rectangle, for example, a square. The isocenter 8, at which the patient's tissue to be treated with the particle beam 6, is located at the center of the imaginary square.

Each pair of photoelectric lines 14a, 14b is illuminated by a test beam 24a, 24b, which has an elongated rectangular cross section and in the manner of a laser line strikes the plane of the photoelectric lines 14a, 14b. The test beams 24a, 24b, which are visible in FIG. 3, intersect the associated photoelectric lines 14a, 14b at a right angle. The isocenter 8 is located at the intersection of the two test beams 24a, 24b. Each test beam 24a, 24b intersects the associated photoelectric line 14a, 14b over only a relatively small portion of the photoelectric line's length L. In one exemplary embodiment, the width A of the photoelectric lines 14a, 14b is less than one-quarter of the length L.

FIG. 4 shows one embodiment of the photoelectric lines 14a, 14b. The orientation of the test body 16 and the photoelectric lines 14a, 14b differs from the case described in conjunction with FIG. 3. For example, in FIG. 4, both pairs of photoelectric lines 14a, 14b are oriented nonorthogonally to the respective test beam 24a, 24b.

In one embodiment, the coordinate display system 10 is suitable for detecting displacements and for quantitatively ascertaining rotations of the test body 16 and/or of the photoelectric lines 14a, 14b relative to the corresponding test beams 24a, 24b. The greater the spacing D between photoelectric lines 14a that are parallel to one another, the greater the angular resolution of the optical measuring system 10.

In one embodiment, before the radiation treatment of the patient begins, calibration of the laser coordinate system 10 is performed, for example, to achieve the three-dimensional correlation shown in FIG. 3 between the test beams 24a, 24b and the photoelectric lines 14a, 14b. The location of the signal S is compared via the individual photoelectric cells 14a, 14b with a neutral location. The neutral location may have been stored in memory upon an initial calibration. Deviations from the correct position and orientation of the photoelectric cells 14a, 14b, which are illustrated, for example, in FIG. 4, are automatically recognized and displayed upon comparison of the location of the signal S obtained with the neutral location. The deviations may also be corrected by a control unit of the medical device 2. The test body 16 may be moved translationally or rotationally via the adjusting device 20, depending on the read-out signal S of each photoelectric line 14a, 14b.

In one embodiment, instead of the individual photoelectric lines 14a, 14b, a beam may be detected using an array of photoelectric cells 22. The photoelectric lines 14 may be disposed in a circle or arc. The circular or arc arrangement increases angular sensitivity.

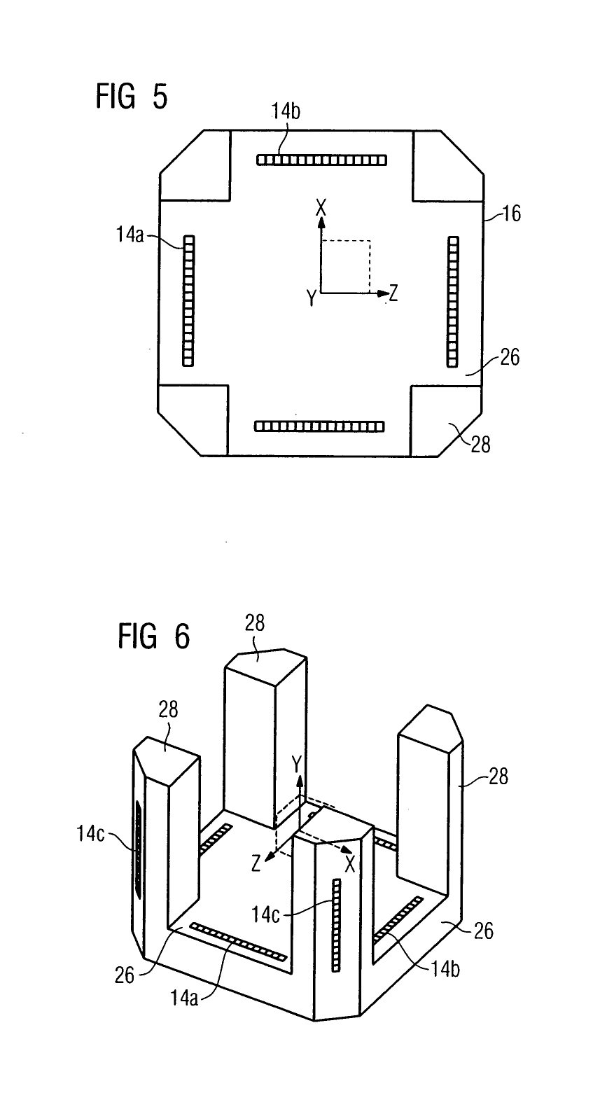

The arrangement of the photoelectric lines 14a, 14b on the test body 16 relative to the X, Y, and Z axes of the coordinate display system 10 is shown in FIGS. 5 and 6. In one embodiment, as shown in FIGS. 5 and 6, the test body 16 is embodied as an upside-down table. The test body 16 has a base 26, which is located in the horizontal X-Z plane of the coordinate display system 10. The test body 16, on an underside of the base 26, may include a connecting element that is operable to connect the test body 16 to the table 18.

In one embodiment, as shown in FIG. 6, the test body 16 includes four pillars 28. The four pillars 28 are used to ascertain deviations in the position of the test body 16 along the vertical Y axis. The four pillars 28 are perpendicular to the base 26. Each of the pillars 28 includes one photoelectric line 14c disposed parallel to the Y axis. The photoelectric lines 14c are intersected by a test beam, which spreads out in a plane that is substantially parallel to the base 26. Alternatively, two pillars 16 may be used to check the position accuracy of the test body 16. The two pillars 16 may include two photoelectric lines 14c that are disposed in such a way that both photoelectric lines 14c can be intersected from one side by the test beam. In this exemplary embodiment, as shown in FIG. 6, four pillars 28 are provided, so that the position accuracy may be checked from all four sides in the X-Z plane.

In one embodiment, at least two photoelectric lines 14c are disposed parallel to the Y axis, which preferably extends symmetrically and have the same spacing (+X, −X) from the isocenter 8. It is possible to check a rotation of the test body 16 or the examination table 18 at the isocenter 8 and a rolling and tilting, or, for example, rotations about the Z axis and about the X axis.

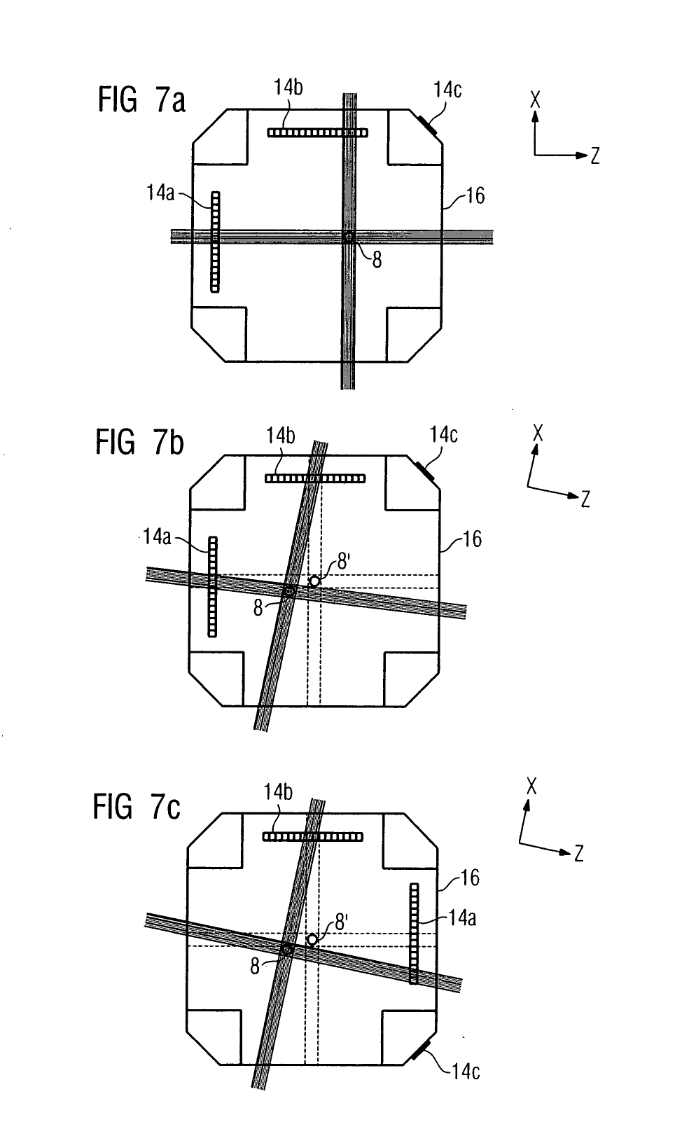

Alternatively to the parallel pairs of photoelectric lines, it is possible for only one photoelectric line 14a, 14b, 14c to be provided parallel to the respective axes of the coordinate display system 10. Displacements of the test body 16 of the kind shown, for example, in FIG. 7a may be ascertained.

If there is only one photoelectric line 14a, 14b, 14c in each direction, then a rotation of the test body 16 may not be detected automatically, because an altered location of the signal S on the photoelectric lines 14a, 14b could indicate both displacement and rotation of the test body 16. The test body 16 may be rotated even if the location of the signal S on both photoelectric lines 14a, 14b matches the neutral location, as is shown in FIG. 7b. In order to ascertain whether a rotation has occurred, the test body 16 is rotated by 90° clockwise, for instance, in the X-Z planes about the pivot point 8′. The pivot point 8′ is the intersection of two straight lines, which are perpendicular to the photoelectric lines 14a, 14b and which intersect the photoelectric lines 14a, 14b in the neutral location. The isocenter 8 is suspected to be at the pivot point 8′.

The orientation of the test body 16 after the 90° clockwise rotation is shown in FIG. 7c. The next check of the location of the signal S on the photoelectric lines 14a, 14b shows a displacement of the signal S along the X axis. Based on this information, it may be determined that the pivot point 8′ of the test body 16 in the X-Z plane is not identical to the isocenter 8. A further clockwise rotation by 90° would also show a displacement of the signal S along the Z axis. With the data obtained, the actual location of the isocenter 8 may be determined, and the rotation of the test body 16 in the X-Z plane is corrected directly by the control unit.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A medical device comprising:
an examination table positionable relative to an isocenter;
an optical coordinate display system that includes at least one radiation source that is operable to emit a test beam; and
a test body for radiation detection that includes at least one photoelectric line, the at least one photoelectric line including a row of photoelectric cells, and
wherein a position of the row of photoelectric cells correlates with the examination table.

2. The medical device as defined by claim 1, wherein a beam length of the test beam is dimensioned relative to the photoelectric line such that the test beam strikes only a small number of the photoelectric cells of the photoelectric line.

3. The medical device as defined by claim 1, wherein a plurality of photoelectric lines are disposed in an angle with one with respect to one another.

4. The medical device as defined by claim 1, wherein a plurality of photoelectric lines is disposed in parallel to one another.

5. The medical device as defined by claim 1, wherein a plurality of photoelectric lines is disposed on an imaginary circle

6. The medical device as defined by claim 1, wherein the test body includes a connecting element that is operable to connect to the examination table.

7. The medical device as defined by claim 1, wherein the test body is operatively coupled at a coupling point to an adjusting device of the examination table.

8. In a test body for checking the position accuracy of an examination table relative to an isocenter of a medical device in a coordinate display system, an improvement comprising:
at least one photoelectric line that includes a row of photoelectric cells.

9. The test body as defined by claim 8, comprising:
a plate like base; and
at least one pillar disposed at a right angle to the base, and
at least two photoelectric lines disposed at an angle with respect to one another,
wherein the at least two photoelectric lines and one further photoelectric line on the pillar are disposed on the base.

10. A method for checking the position of an examination table relative to an isocenter of a medical device in a coordinate display system, wherein a test body with a photoelectric line of a row of photoelectric cells is put in a testing position, the method comprising:
irradiating the photoelectric line with a test beam emitted by a radiation source of the coordinate display system;
picking up a signal using the photoelectric line; and
ascertaining the position of the test body relative to the isocenter as a function of the signal.

11. The method as defined by claim 10, comprising: comparing the location of the signal of the photoelectric line with a neutral location.

12. The method as defined by claim 10, comprising: irradiating the test body from a plurality of directions.

13. The method as defined by claim 12, wherein ascertaining the position relative to the isocenter (8) includes moving the test body and picking up the signal using the photoelectric line.

14. The medical device according to claim 1, wherein the medical device is a radiation therapy device.

15. The medical device according to claim 1, wherein the at least one radiation source includes a laser emitter.

16. The medical device as defined by claim 3, wherein the plurality of photoelectric lines is disposed in a right angle with respect to one another.

17. The test body as defined by claim 9, wherein the test body is embodied as an upside-down table.

18. The method as defined by claim 12, wherein irradiating the test body from a plurality of directions includes irradiating from three directions parallel to the axes of the coordinate display system.
